(19) United States
(12) Patent Application Publication
(10) Pub. No.: US 2026/0340839 A1
(43) Pub. Date: Oct. 29, 2026

(54) DETERMINING MOVEMENT OF PASSIVE PHYSICAL INTERFACE CONTROLS

(71) Applicant: Adobe Inc., San Jose, CA (US)

(72) Inventors: Chang Xiao, Sunnyvale, CA (US); Eunyee Koh, San Jose, CA (US); Daniel De Jesus Campos Zamora, Seattle, WA (US); Alexa Fay Siu, Sunnyvale, CA (US); Mustafa Doga Dogan, Basel (CH)

(73) Assignee: Adobe Inc., San Jose, CA (US)

(21) Appl. No.: 19/192,927

(22) Filed: Apr. 29, 2025

(51) Int. Cl. G06T 7/20; G06T 5/50; G06T 5/70; G06V 10/74

(52) U.S. Cl. CPC G06T 7/20; G06T 5/50; G06T 5/70; G06V 10/761; G06T 2207/20221

(57) ABSTRACT

In implementation of techniques for determining movement of passive physical interface controls, a computing device implements an interface system to receive a first image depicting a composite pattern formed by a first pattern overlapping a second pattern by a first amount, the first pattern incorporated onto a physical control. The interface system also receives a second image depicting a different composite pattern formed by the first pattern overlapping the second pattern by a second amount. Based on a comparison of the composite pattern and the different composite pattern, the interface system determines a displacement of the first pattern in relation to the second pattern. The interface system then performs an action based on the displacement.

### BACKGROUND

Physical interface controls allow interaction with a device or system using tangible, touch-based inputs to control various functionalities. For instance, physical interface controls are used in electronics, appliances, industrial systems, and other applications. Examples of physical interface controls include buttons, joysticks, switches, dials, and sliders. However, physical interface controls typically involve complex electronic components and also involve a power source to perform an intended function. Implementing physical interface controls therefore involves electronic expertise and causes increased power consumption in real world scenarios.

### SUMMARY

Techniques and systems for determining movement of passive physical interface controls are described. In an example, an interface system receives a first image depicting a composite pattern formed by a first pattern overlapping a second pattern by a first amount, the first pattern incorporated onto a physical control. For instance, the physical control is a passive, non-electronic control. In some examples, the physical control is at least one of a button, a joystick, a switch, a dial, or a slider.

The interface system also receives a second image depicting a different composite pattern formed by the first pattern overlapping the second pattern by a second amount. For example, the composite pattern and the different composite pattern depict Moiré patterns formed by the first pattern and the second pattern overlapping at different amounts. In some examples, the first image and the second image are frames of a digital video captured during the displacement of the physical control.

Based on a comparison of the composite pattern and the different composite pattern, the interface system determines a displacement of the first pattern in relation to the second pattern. For instance, the comparison of the composite pattern and the different composite pattern involves at least one of a one-dimensional translation, a two-dimensional translation, or a rotational translation formed by movement of the first pattern relative to the second pattern. In some examples, the interface system identifies the composite pattern depicted in the first image, generates a visual signal by adjusting a perspective of the composite pattern, generates a blurred visual signal, and fits a sine wave to the blurred visual signal to determine the displacement.

The interface system then performs an action based on the displacement. In some examples, the interface system transmits information related to the displacement to a device configured for performing the action based on the displacement.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for determining movement of passive physical interface controls as described herein.

FIG. 2 depicts a system in an example implementation showing operation of an interface module for determining movement of passive physical interface controls.

FIG. 3 depicts an example of different Moiré effects for use with determining movement of passive physical interface controls.

FIG. 4 depicts an example of a button for use with determining movement of passive physical interface controls.

FIG. 5 depicts an example of a joystick for use with determining movement of passive physical interface controls.

FIG. 6 depicts an example of a switch for use with determining movement of passive physical interface controls.

FIG. 7 depicts an example of a dial for use with determining movement of passive physical interface controls.

FIG. 8 depicts an example of a slider for use with determining movement of passive physical interface controls.

FIG. 9 depicts an example of processing images for determining movement of passive physical interface controls.

FIG. 10 depicts a procedure in an example implementation of determining movement of passive physical interface controls.

FIG. 11 depicts a procedure in an additional example implementation of determining movement of passive physical interface controls.

FIG. 12 illustrates an example system including various components of an example device that can be implemented as any type of computing device as described and/or utilized with reference to FIGS. 1-11 to implement embodiments of the techniques described herein.

### DETAILED DESCRIPTION

### Overview

Physical interface controls provide tactile feedback when interacting with a device. For this reason, physical interface controls are useful for applications in education, gaming, data visualization, and other tasks involving controlling a device to perform a specific function. Examples of physical interface controls include buttons, joysticks, switches, dials, and sliders. However, physical interface controls are typically electronically-based and involve embedded circuits and power to function, making them complex to produce and integrate into systems.

Conventional interface control techniques attempt to monitor passive interface controls that are non-electronic in an attempt to avoid using embedded circuits or power for controls. However, these conventional interface control techniques involve detecting changes in magnetic fields, air pressure, touch, or sound to determine whether a passive interface control has been actuated. Additionally, these conventional interface control techniques are closely coupled to micro-controllers or are in close proximity to mobile devices to detect displacement.

Techniques and systems are described for determining movement of passive physical interface controls that overcome these limitations. For instance, the passive physical interfaces involve tangible controls, including buttons, joysticks, switches, dials, sliders, or other controls that involve two patterns integrated on different parts that are configured to move in relation to each other. When the patterns overlap as a result of movement of the parts, a Moiré pattern is produced. The Moiré pattern is a visual phenomenon that is specific to an amount of overlap between the patterns. Therefore, images of the passive physical interface control are captured before and after movement using a camera of a mobile device, Augmented Reality (AR)/Virtual Reality (VR) goggles, or other device. A displacement between the parts of the passive physical interface control is then determined based on comparing the Moiré patterns depicted in the images, and an action is performed based on the displacement. For example, instructions to lower a temperature are generated based on determining the displacement from a passive slider assigned to a thermostat.

An interface system begins in this example by receiving an input including a first image and a second image. The first image and the second image depict a physical interface control including a first part that moves relative to a second part. The physical interface control also includes a first pattern affixed to the first part in a way that overlaps a second pattern affixed to the second part. For example, the first pattern is printed onto a transparent medium so that the second pattern is visible when overlapped by the first pattern. In this example, the first pattern and the second pattern are periodic patterns that produce a Moiré pattern when overlapping, which results in a different visual effect depending on different positions of the first pattern overlapping the second pattern.

In an example, the physical interface control is actuated between capture of the first image and the second image, including moving the first part relative to the second part. For example, the first image and the second image are frames of a digital video captured by a camera of a mobile device, AR/VR goggles, or other device while the physical interface control is actuated. Because the first pattern, affixed to the first part, is in a different position relative to the second pattern, affixed to the second part, the first image depicts a different Moiré pattern than the second image.

The interface system then identifies a first Moiré pattern in the first image and a second Moiré pattern in the second image. To do this, the interface system identifies dots or other markers incorporated into the physical interface control to identify a location of the changing Moiré patterns.

After identifying the first Moiré pattern in the first image and the second Moiré pattern in the second image, the interface system processes the images by generating a blurred first Moiré pattern and a blurred second Moiré pattern, based on the first Moiré pattern and the second Moiré pattern, respectively. In some examples, this additionally involves transforming a perspective of the first image and the second image to straighten or realign the perspective of the images. Additionally, the interface system fits sine waves to the blurred first Moiré pattern and the blurred second Moiré pattern, resulting in a first set of peaks and a second set of peaks. The first set of peaks and the second set of peaks, for instance, indicate levels of color contrast between pixels of the blurred first Moiré pattern and the blurred second Moiré pattern. Because the Moiré patterns amplify an amount of movement between the first part and the second part in this example, a comparison of the first set of peaks and the second set of peaks provides a representation of the displacement between the first part and the second part.

The interface system then determines the displacement of the first part of the physical interface control relative to the second part, based on the first set of peaks and the second set of peaks. For example, the interface system compares locations of the first set of peaks and the second set of peaks, which correlate to the displacement of the first part of the physical interface control relative to the second part.

In some examples, the interface system also generates an output including instructions to cause performance of an action based on the displacement. For example, the physical interface control is a passive widget pre-associated with an action that is performed when the physical interface control is actuated, controlled, or moved. Examples of applications of the action include, but are not limited to, turning a light on or off, adjusting volume, adjusting temperature, powering a device on or off, or causing movement or an apparatus. The interface system transmits the instructions to another device responsible for performance of the action or causes performance of the action directly. In some examples, the physical interface control is incorporated into a smart come environment for controlling one or more devices in conjunction with the mobile device, the AR/VR goggles, or other device capable of capturing the first image and the second image.

Determining movement of passive physical interfaces in this manner overcomes the limitations of conventional interface control techniques that involve detecting changes in magnetic fields, air pressure, touch, or sound to determine whether a passive interface control has been actuated. For example, determining a displacement of parts of a passive physical interface control based on associated Moiré patterns avoids detecting changes in magnetic fields, air pressure, touch, or sound. Additionally, the described techniques for determining movement of passive physical interface controls are capable of being performed using images captured far from the passible physical interface. This is because Moiré patterns amplify movement between two overlapping patterns, allowing for determination of a displacement between two parts of the passive physical interfaces at remote distances. This is also an improvement over the conventional interface control techniques, which involve closely coupled micro-controllers or mobile devices in close proximity to detect the displacement.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

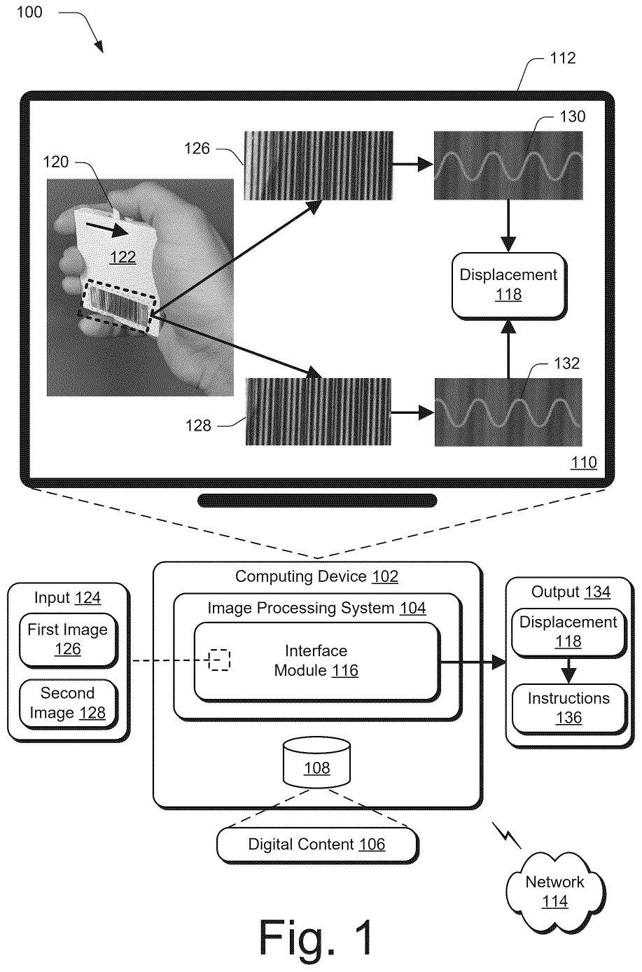

FIG. 1 is an illustration of a digital medium environment 100 in an example implementation that is operable to employ techniques and systems for determining movement of passive physical interface controls described herein. The illustrated digital medium environment 100 includes a computing device 102, which is configurable in a variety of ways.

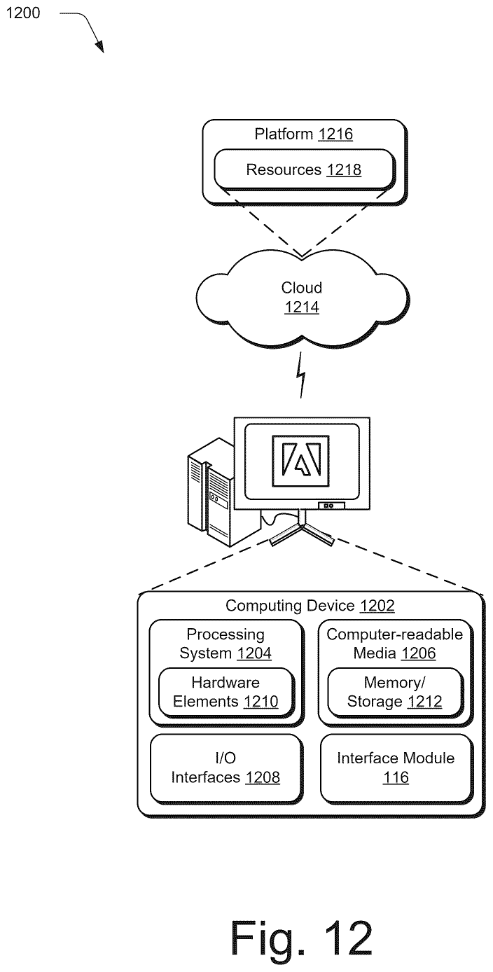

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 12.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes an interface module 116 which is illustrated as incorporated by the image processing system 104 to process the digital content 106. In some examples, the interface module 116 is separate from the image processing system 104 such as in an example in which the interface module 116 is available via the network 114.

The interface module 116 is configured to determine a displacement 118 of a first part 120 of a physical interface control relative to a second part 122 of the physical interface control. The displacement 118, for instance, indicates an amount of movement of the physical interface control, indicating actuation of movement of the first part 120 relative to the second part 122. Examples of the physical interface control include a button, a joystick, a switch, a dial, or a slider, which are passive, non-electronic widgets in this example. The first part 120 of the physical interface control, for instance, features a first pattern, and the second part 122 of the physical interface control features a second pattern. The first pattern and the second pattern are affixed to the first part 120 and the second part 122, respectively, so that the patterns overlap to form a composite pattern, which is a Moiré pattern in this example. The Moiré pattern is a visual effect that is produced when two periodic patterns are superimposed. Here, the first pattern is depicted on a transparent material that overlays the second pattern, which is printed on an opaque material (or vice versa) so that the patterns produce a Moiré pattern when overlapping.

Movement of the first part 120 relative to the second part 122 produces different Moiré patterns because the movement causes the first pattern and the second pattern to overlap in different positions. As shown in this example, the physical interface control is a switch. Moving the switch causes the first pattern to slide past the second pattern, changing the Moiré pattern displayed in a window of the switch. The interface module 116 leverages the different Moiré patterns to determine a precise amount of movement, including the displacement 118, between the first part 120 and the second part 122. For example, the interface module 116 receives a first image 126 depicting a first Moiré pattern formed by the first pattern and the second pattern overlapping at an initial position, as well as a second image 128 depicting a second Moiré pattern formed by the first pattern and the second pattern overlapping at a subsequent position based on movement of the first part 120 relative to the second part 122. The first image 126 and the second image 128 in this example are captured by a camera associated with a headset or other mobile device. For instance, a user wears the headset while actuating the physical interface control. Although the physical interface control is passive in this example, the interface module 116 determines an action to cause based on determining the displacement 118 of the first part 120 relative to the second part 122, as viewed from the headset.

To determine the displacement 118 of the first part 120 relative to the second part 122, the interface module 116 transforms a perspective of the first image 126 and the second image 128, to correct images that are captured diagonally or off-center. In some examples, this also involves detecting a first Moiré pattern in the first image 126 and a second Moiré pattern in the second image 128. The interface module 116 then blurs the first image 126 and the second image 128 and detects a first set of peaks 130 and a second set of peaks 132 in the first Moiré pattern and the second Moiré pattern, respectively. The first set of peaks 130 and the second set of peaks 132, for example, are sine waves that correspond to pixel variations over the blurred first image and the blurred second image. By comparing the first set of peaks 130 of the first Moiré pattern and the second set of peaks 132 of the second Moiré pattern, the interface module 116 determines the displacement 118 between the first part 120 and the second part 122. The displacement 118, for instance indicates a precise measurement of movement of the first part 120 relative to the second part 122.

After determining the displacement 118 between the first part 120 and the second part 122, the interface module 116 generates an output 134 including instructions 136 for performing an action. In this example, the switch is a light switch. After the interface module 116 determines the displacement 118 between the first part 120 and the second part 122, the interface module 116 generates instructions 136 to turn on a light pre-associated with the switch in a smart home environment. In other examples, the interface module 116 communicates data indicating the displacement 118 to a different device or system for performance of an action based on the displacement 118.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Determining Movement of Passive Physical Interface Controls

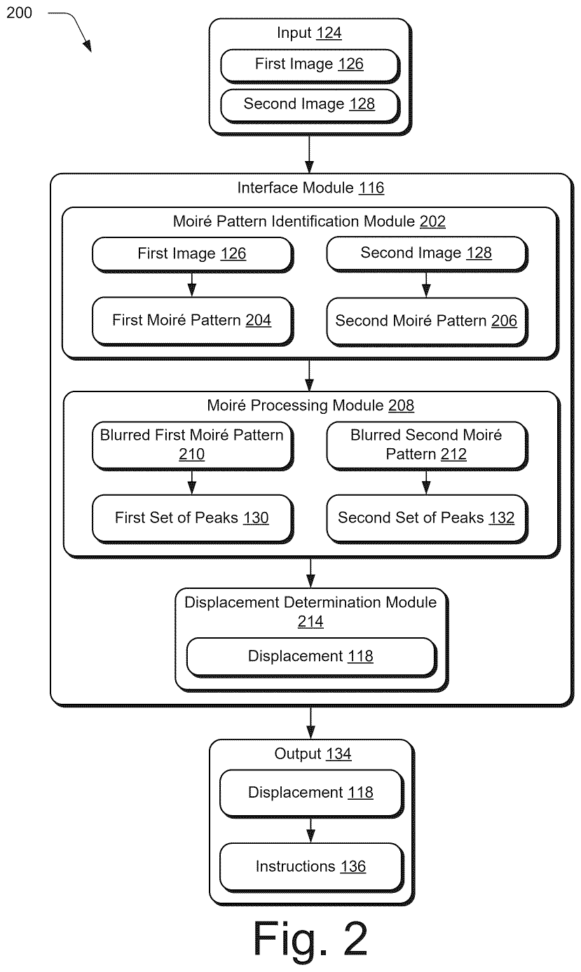

FIG. 2 depicts a system 200 in an example implementation showing operation of the interface module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-12.

To begin in this example, an interface module 116 receives an input 124 including a first image 126 and a second image 128. The first image 126 and the second image 128, for instance, depict a physical interface control including a first part 120 and a second part 122. The first part 120 moves relative to the second part 122 when the first part 120 of the physical interface control (e.g., a button, joystick, switch, dial, slider, etc.) is actuated or moved. The physical interface control also includes a first pattern affixed to the first part 120 in a way that overlaps a second pattern affixed to the second part 122. In this example, the first pattern and the second pattern are periodic patterns that produce a Moiré pattern when overlapping, which results in a different visual effect depending on different positions of the first pattern overlapping the second pattern.

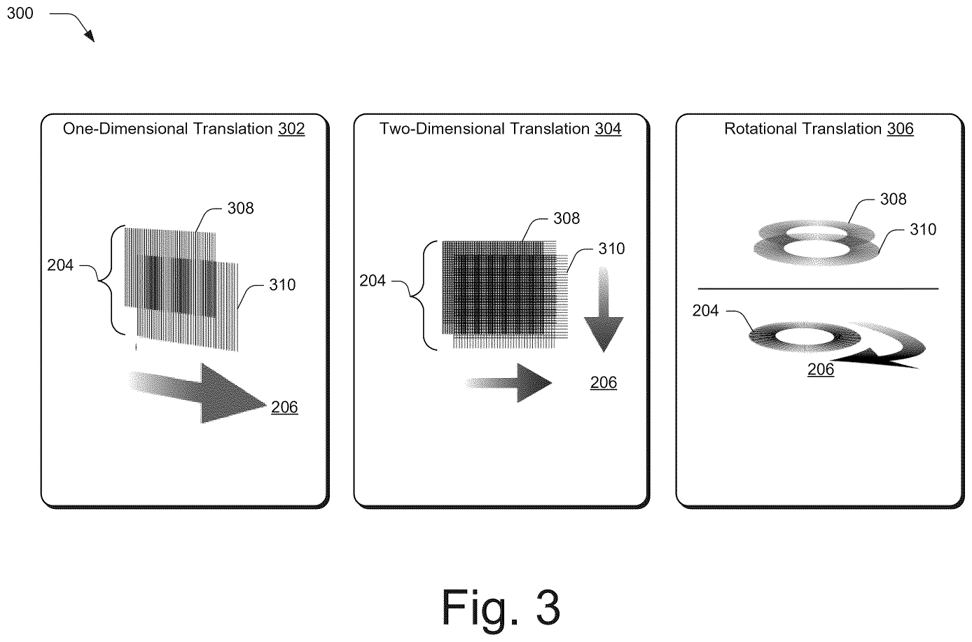

In this example, the physical interface control is actuated, moved, or interacted with between capture of the first image 126 and the second image 128, including moving the first part 120 relative to the second part 122. Because the first pattern, affixed to the first part 120, is in a different position relative to the second pattern, affixed to the second part 122, the first image 126 depicts a different Moiré pattern than the second image 128, as explained in further detail with respect to FIG. 3.

The interface module 116 includes a Moiré pattern identification module 202 that is configured to identify a first Moiré pattern 204 in the first image 126 and a second Moiré pattern 206 in the second image 128. To do this, the pattern identification module 202 identifies dots or other markers incorporated into the physical interface control to identify a location of the changing Moiré patterns. In other examples, the pattern identification module 202 leverages a machine learning model trained to identify Moiré patterns depicted in digital images.

The interface module 116 also includes a Moiré processing module 208. After identifying the first Moiré pattern 204 in the first image 126 and the second Moiré pattern 206 in the second image 128, the Moiré processing module 208 generates a blurred first Moiré pattern 210 and a blurred second Moiré pattern 212, based on the first Moiré pattern 204 and the second Moiré pattern 206, respectively. In some examples, this involves transforming a perspective of the first image 126 and the second image 128 to straighten or realign the perspective of the images. Additionally, the processing module 208 fits sine waves to the blurred first Moiré pattern 210 and the blurred second Moiré pattern 212, resulting in a first set of peaks 130 and a second set of peaks 132. The first set of peaks 130 and the second set of peaks 132, for instance, indicate levels of color contrast between pixels of the blurred first Moiré pattern 210 and the blurred second Moiré pattern 212. Because the Moiré patterns amplify an amount of movement between the first part 120 and the second part 122 in this example, comparing the first set of peaks 130 and the second set of peaks 132 provide graphical representations of the displacement 118 between the first part 120 and the second part 122.

The interface module 116 also includes a displacement determination module 214, which is configured to determine the displacement 118 of the first part 120 of the physical interface control relative to the second part 122, based on the first set of peaks 130 and the second set of peaks 132. For example, the displacement determination module 214 determines a comparison of locations of the first set of peaks 130 and the second set of peaks 132 to determine the displacement 118 of the first part 120 of the physical interface control relative to the second part 122.

In some examples, the interface module 116 also generates an output 134 including instructions 136 to cause performance of an action based on the displacement 118. For example, the physical interface control corresponds to a button, a joystick, a switch, a dial, a slider, or other control associated with an action that is performed when the physical interface control is actuated, controlled, or moved. Examples of applications of the action include, but are not limited to, turning a light on or off, adjusting volume, adjusting temperature, powering a device on or off, or causing movement or an apparatus. In some examples, the physical interface control is incorporated into a smart come environment for controlling one or more devices in conjunction with a VR/AR headset, smart glasses, a mobile device, or other device capable of capturing the first image 126 and the second image 128.

FIGS. 3-9 depict stages of determining movement of passive physical interface controls. In some examples, the stages depicted in these figures are performed in a different order than described below.

FIG. 3 depicts an example 300 of different Moiré effects for use with determining movement of passive physical interface controls. Moiré patterns are formed when two square waves of marginally varied frequencies overlap. For example, a first pattern 308 overlaps a second pattern 310. A Moiré pattern is a combined wave that includes a low base frequency that amplifies and captures the differential positioning of the two square waves, for instance the first pattern 308 and the second pattern 310. For example, two periodic stripe patterns are superimposed without intervening space, the period of the Moiré fringes, Tₘ, is solely influenced by the periods of the individual patterns Tₐ and T_{b}, expressed by the relation

$${T}_{m} = \frac{{T}_{a} {T}_{b}}{{T}_{a} - {T}_{b}} .$$

Consequently, a subtle displacement, Δ_{b}, in the upper layer results in a displacement in the Moiré fringes, represented as

$${Δ}_{m} = \frac{{T}_{a} {Δ}_{b}}{{T}_{a} - {T}_{b}} .$$

As shown, the Moiré effect amplifies the displacement occurring on the top layer.

Examples of different Moiré patterns involve a one-dimensional translation 302, a two-dimensional translation 304, and a rotational translation 306. Different translations of Moiré patterns, for instance, are leveraged to facilitate interaction with a variety of passive interfaces.

The one-dimensional translation 302 involves two layers of thin parallel lines with different spacing or periods that move along a single axis. Movements orthogonal to the parallel lines generate a visual signal of lower frequency but with higher sensitivity to displacement. Sliders, buttons, and switches are examples of passive interfaces that involve the one-dimensional translation 302 because they involve movement along a single axis. As illustrated in this example, the first pattern 308 is configured to side across the second pattern 310 in one direction, resulting in the one-dimensional translation 302 from a first Moiré pattern 204 to a second Moiré pattern 206.

The two-dimensional translation 304 is an extension of the one-dimensional translation 302 into two dimensions by creating two grids of perpendicular lines with varying periods. Translation movements along the XY plane generate a signal that appears like a larger grid. Joysticks configured for thumb-slide motion that glide across a plane are an example of passive interfaces that involve the two-dimensional translation 304. As illustrated in this example, the first pattern 308 is configured to move across the second pattern 310 in two directions, resulting in the two-dimensional translation 304 from a first Moiré pattern 204 to a second Moiré pattern 206.

The rotational translation 306 involves two concentric patterns of lines with different angular offsets. A shift in the relation between one Moiré pattern to another Moiré pattern yields an altered radial pattern that corresponds to the degree of rotational displacement. Dials are an example of passive interfaces that involve the rotational translation 306. As illustrated in this example, the first pattern 308 is configured to rotate over the second pattern 310, resulting in the rotational translation 306 from a first Moiré pattern 204 to a second Moiré pattern 206.

Although these examples involve Moiré patterns formed by overlapping periodic patterns, other types of Moiré patterns are also contemplated for passive physical interfaces, including, but not limited to, dots, hexagonal meshes, colors, and various geometries and visual effects.

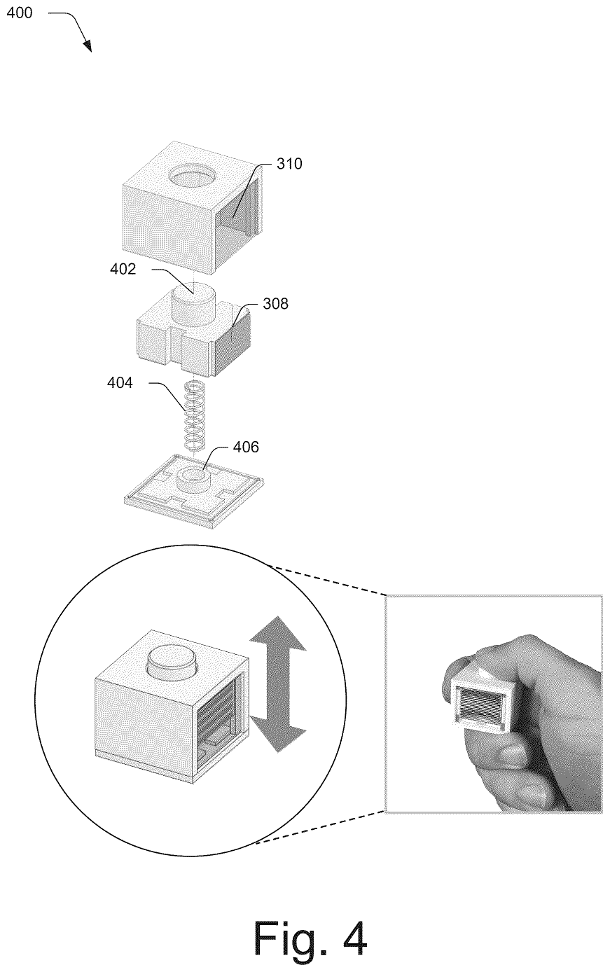

FIG. 4 depicts an example 400 of a button for use with determining movement of passive physical interface controls. As illustrated, this example depicts a button 402 that facilitates a one-dimensional translation 302 of a Moiré pattern.

Moiré patterns involve narrow line features to generate a visual signal that is capable of detection by a camera. Typically, the smaller differences between two periods of fringe layers result in a stronger signal of the Moiré pattern. In an example, a difference of 0.05 mm generates a salient visual signal for line widths ranging from 0.1-0.3 mm, however Moiré patterns are detectable in other ranges as well.

Passive physical interface controls are created in some examples using a variety of techniques. The first part 120, the second part 122, and other components of the passive physical interface control are three-dimensional (3D) printed. For example, fused deposition modeling (FDM) 3D printing is used for creating mechanical structures of the passive physical interface controls to facilitate the one-dimensional translation 302, the two-dimensional translation 304 or the rotational translation 306. In this example, the mechanical structures are 3D printed using PLA material. However, other examples involve mechanical structures that are 3D printed using other materials or manufactured using other means. Some passive physical interface control examples additionally involve springs or other additional parts.

To integrate the first pattern 308 and the second pattern 310 onto the first part 120 and the second part 122, respectively, for producing the Moiré patterns, the first pattern 308 and the second pattern 310 are printed on a variety of different materials in different examples. For instance, the first pattern 308 and the second pattern 310 are printed on paper using a laser printer in some examples. Paper components depicting the first pattern 308 and the second pattern 310 are then integrated onto the 3D printed structures in this example, which provides stability during user interactions. In some examples, the first pattern 308 and/or the second pattern 310 are printed with visible ink or invisible ink, including ink visible using ultraviolet light.

In some examples, the first pattern 308 is printed on a transparent material and placed into window features in the 3D structures so that the first pattern 308 is capable of transparently overlapping the second pattern 310 to form the Moiré pattern. For example the second pattern 310 is printed on an opaque material for layering beneath the first pattern 308.

As illustrated, this example depicts a button 402 that facilitates a one-dimensional translation 302 of a Moiré pattern. The button 402 includes a first pattern 308 incorporated onto a housing that moves in relation to a second pattern 310 incorporated into a stationary top housing when the button 402 is pressed. Because the first pattern 308 is printed on a transparent material in this example, the first pattern 308 is configured to transparently overlay the second pattern 310. For instance, the button 402 moves along a vertical axis, connected via a compression spring 404 to a bottom cap 406. When pressure is exerted on the button 402, the first pattern 308 moves relative to the second pattern 310, producing the one-dimensional translation 302 of the Moiré pattern. When the pressure is removed from the button 402, the first pattern 308 again moves relative to the second pattern 310, returning the button 402 to a resting state.

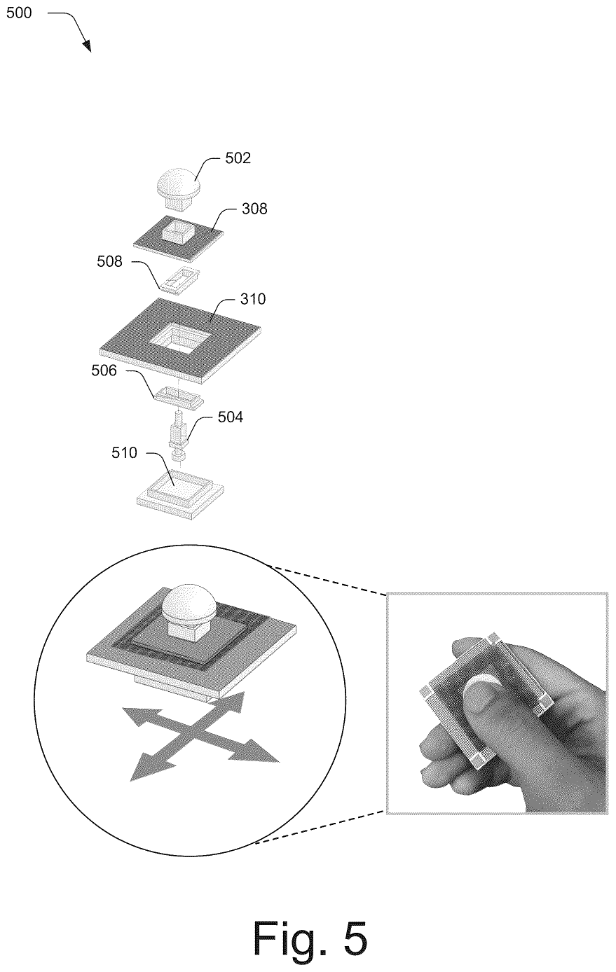

FIG. 5 depicts an example 500 of a joystick for use with determining movement of passive physical interface controls. As illustrated, this example depicts a joystick 502 that facilitates a two-dimensional translation 304 of a Moiré pattern.

The joystick 502 in this example is attached to the first pattern 308, which is attached to a pin 504 to move relative to the second pattern 310 via an x-axis slot 506 and a y-axis slot 508, affixed to a bottom cap 510. The joystick 502, therefore, is configured to move along the x-axis, the y-axis, or a combination of the x-axis and the y-axis. Accordingly, the first pattern 308 attached to the joystick 502 moves relative to the second pattern 310, producing the two-dimensional translation 304 of the Moiré pattern.

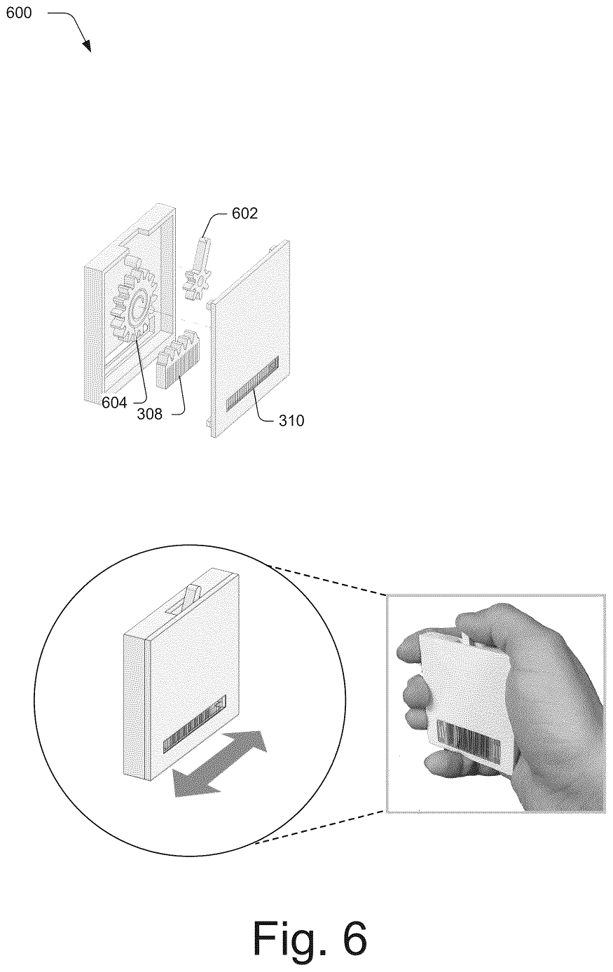

FIG. 6 depicts an example 600 of a switch for use with determining movement of passive physical interface controls. As illustrated, this example depicts a switch 602 that facilitates a one-dimensional translation 302 of a Moiré pattern.

The switch 602 in this example is a geared switch having cogs that are in communication with cogs of a piece featuring the first pattern 308. Using a coil-spring gear 604, the piece featuring the first pattern 308 is configured to move along a y-axis relative to the second pattern 310. Accordingly, the first pattern 308 is controlled by the switch 602 to move relative to the second pattern 310, producing the one-dimensional translation 302 of the Moiré pattern.

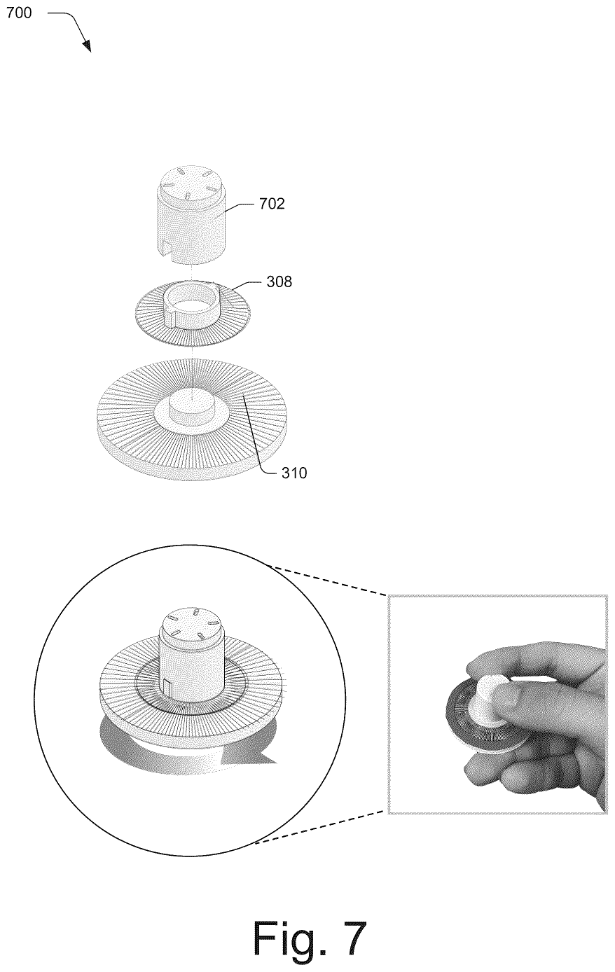

FIG. 7 depicts an example 700 of a dial for use with determining movement of passive physical interface controls. As illustrated, this example depicts a dial 702 that facilitates a rotational translation 306 of a Moiré pattern.

The dial 702 in this example is connected to a first pattern 308 that is arranged around a central axis. The dial 702 is configured to rotate the first pattern 308 relative to a second pattern 310, which is fixed to a base. Because the first pattern 308 is printed on a transparent material in this example, the first pattern 308 is configured to overlay the second pattern 310, producing a Moiré pattern. Accordingly, the first pattern 308 is controlled by the dial 702 to move relative to the second pattern 310, producing the rotational translation 306 of the Moiré pattern when the dial 702 is turned.

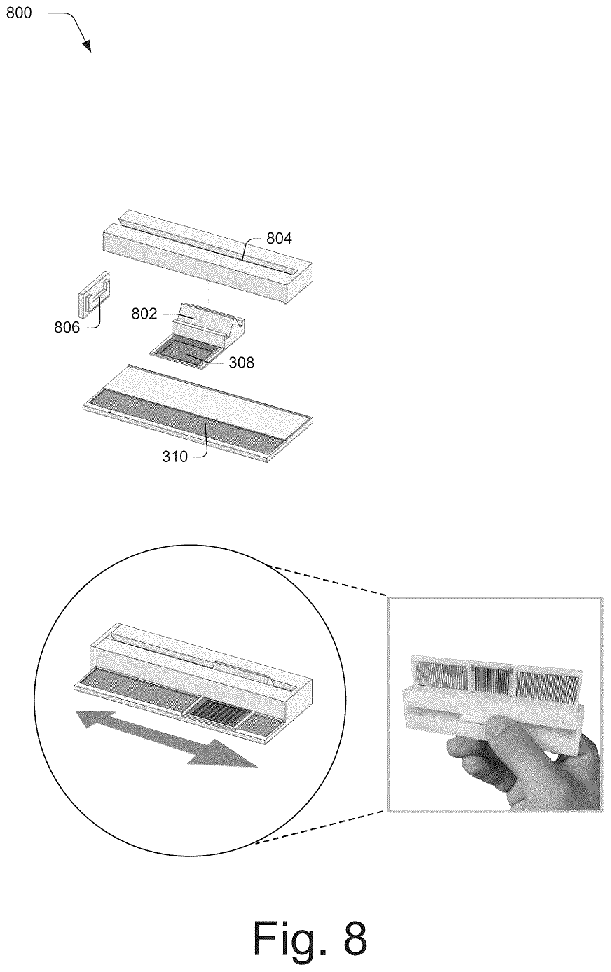

FIG. 8 depicts an example 800 of a slider for use with determining movement of passive physical interface controls. As illustrated, this example depicts a slider 802 that facilitates a one-dimensional translation 302 of a Moiré pattern.

The slider 802 in this example is connected to a first pattern 308. For example, the slider 802 includes a window through which the first pattern 308 is viewed. The slider 802 slides along a guide strip of a housing 804, moving the first pattern 308 relative to a base including a second pattern 310 affixed to the base. Because the first pattern 308 is printed on a transparent material in this example, the first pattern 308 is configured to slide over the second pattern 310, producing a Moiré pattern when overlapping. In some examples, the one-dimensional translation 302 involves a cap 806 to prevent over-extension of the slider 802 relative to the base. Accordingly, the first pattern 308 is controlled by the slider 802 to move in a horizontal direction relative to the second pattern 310, producing the one-dimensional translation 302 of the Moiré pattern.

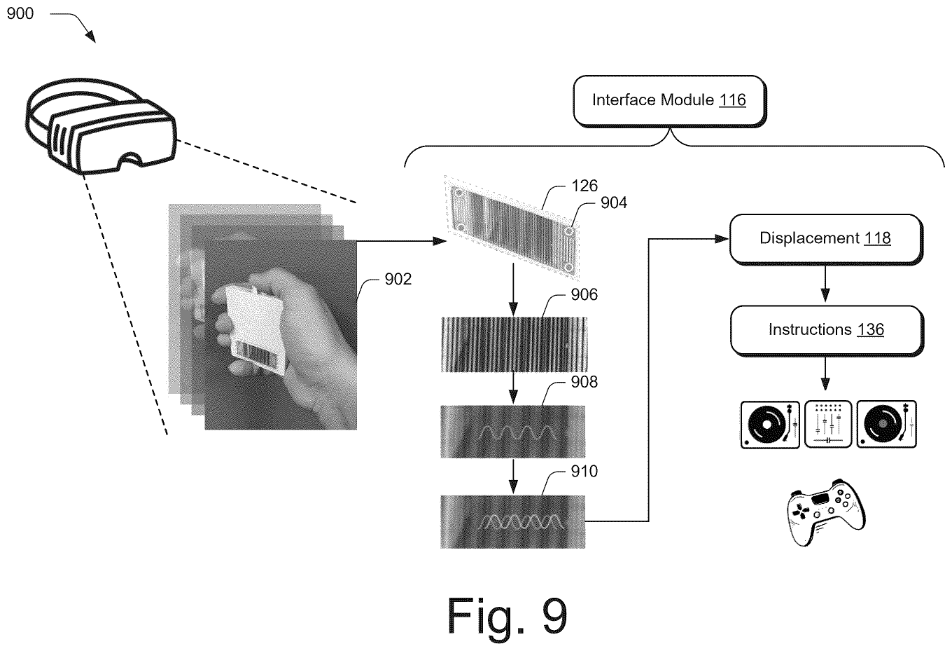

FIG. 9 depicts an example 900 of processing images for determining movement of passive physical interface controls. As shown in this example, the interface module 116 receives frames of a digital video 902, including a first image 126 that depicts a first Moiré pattern 204.

To begin, a Moiré pattern identification module 202 identifies a first Moiré pattern 204 in the first image 126. To do this, the pattern identification module 202 identifies dots 904 or other markers incorporated into the physical interface control to identify a location of the changing Moiré patterns. For example, the pattern identification module 202 applies a color threshold to separate masks of the markers, and locate the four inner corners, which correspond to a location of the first Moiré pattern 204. In other examples, the pattern identification module 202 leverages a machine learning model trained to identify Moiré patterns depicted in digital images.

To convert the visible alteration in the Moiré pattern into a displacement signal, an image processing pipeline is used. Here, Moiré fringes are be represented as a sinusoidal function as A sin(wx+φ)+B. For example, a Moiré processing module 208 transforms the identified region into a rectified view, generating a transformed perspective Moiré pattern 906. This facilitates identification of Moiré pattern changes in a standardized form regardless of the camera position. Given that the Moiré pattern exhibits multiple high-frequency components, the processing module 208 applies a Gaussian Blur filter following the conversion of the Moiré image to grayscale, generating a blurred Moiré pattern 908. In this example, the kernel size selected for the Gaussian Blur is equivalent to 10% of the rectified view's length. However, other examples involve other types of blurring applied to the first image 126. In some examples, an average intensity is calculated along the y-axis of the blurred Moiré pattern 908, thereby generating a one-dimensional intensity signal for use to estimate the Moiré displacement effectively.

A displacement determination module 214 then determines a displacement 118 of the first Moiré pattern 204 relative to a second Moiré pattern 206 of the digital video 902. To do this, the displacement determination module 214 normalizes the intensity signal to confine it within a range of −1 to 1 and then fits a sinusoidal function given by ƒ(x; A, B, φ)=A sin(wx+φ)+B to the first Moiré pattern 204, which is repeated for the second Moiré pattern 206. Here w is a constant and is determined by w=2π(Tₐ−T_{b})/(TₐT_{b}), considering Tₐ and T_{b} are known values from the production time. After fitting the sinusoidal function, the parameter φ, which is acquired during the fitting, is leveraged to estimate the displacement 118, corresponding to movement 910 of the signal from the first image 126 to the second image 128. In an example during the sinusoidal fitting, A is restricted to be a positive value and φ in the range between 0 to 2π. Given φᵢ represents the estimated phase from the i-th frame, the displacement 118 Δxᵢ between frame i and frame i−1 is therefore calculated using the equation:

$$Δ {x}_{i} = \frac{Δϕ {T}_{m}}{2 π}$$

where Δφ equals φᵢ−φᵢ₋₁, if φᵢ≥φᵢ₋₁, or φᵢ+2π−φᵢ₋₁ if φᵢ<φᵢ₋₁. In this example, frames i and frame i−1 are sufficiently close to each other, preventing the Moiré pattern from shifting by more than one period between the two frames.

This transforms the first image 126 depicting the first Moiré pattern 204 into displacement signals in real-time, making them adaptable for controlling a wide array of applications. After determining the displacement 118 in this example, the interface module 116 generates instructions 136 for performing an action. In an example, the physical interface control in this example is a sound mixing interface. After the interface module 116 determines the displacement 118 between the first part 120 and the second part 122, which involves a switch control in this example to power a device on or off, the interface module 116 generates instructions 136 for transmission to a different device to power the device on or off corresponding to the displacement 118.

Passive physical interface controls have a variety of applications in Augmented Reality (AR)/Virtual Reality (VR), robotics, art, and smart home systems. Because the passive physical interface controls do not electronically-based, they are useful for implementation in multiple scenarios.

In AR/VR training simulations, physical interface controls shaped as surgical instruments or vehicle controls, for instance, allow users to practice real-world tasks with realistic haptic feedback. In AR/VR gaming applications, physical interface controls involve gaming controls or props including switches, triggers, dials, etc., which have virtual counterparts in a game and provide an immersive experience without complex electronic controllers. These passive interfaces improve immersion, enhance learning, and create realistic interactions within AR/VR environments.

In robotics, passive physical interfaces enhance intuitiveness and accessibility for controlling robotic actions. For example, a set of controls is used to adjust a robot's movement parameters, including speed or direction, by physical adjustment. Additionally, dials or sliders allow users to control robotic arms for precision-based tasks including assembly or surgery, translating manual inputs into digital commands. This provides a tactile and intuitive means of controlling robots.

Passive physical interface controls also have applications in art to create interactive and intuitive ways for artists to manipulate digital or physical media. For example, artists use controls to guide robotic drawing arms, influencing brush strokes or engraving patterns in a tactile way without digital input. In digital painting or sculpting applications, sliders and dials are used to adjust properties including brush size, opacity, or tool hardness, providing a tactile alternative to on-screen menus.

Additionally, passive physical interface controls enhance smart home applications by providing intuitive and tactile ways to interact with home automation systems as an alternative to using screens or voice commands. For example, switches, sliders or dials are used to control lighting intensity, paired with a smart lighting system. Additionally, sliders or dials are used to control temperature level, paired with a smart heating and/or air conditioning system. A variety of other home appliances and electronics are capable of being controlled with passive physical interface controls, including locks, doorbells, alarms, entertainment systems, sound systems, refrigerators, ovens, microwaves, washing machines, dryers, vacuum systems, kitchen appliances, garage door openers, automated blinds and curtains, sprinklers, air purifiers, humidifiers, dehumidifiers, fans, lighting color controls, light dimmers, and a variety of other objects and devices. Accordingly, passive physical interface controls offer a user-friendly way to interact with smart home devices.

Because passive physical interface controls are 3D printed in some examples, they are applicable to numerous applications and workflows. For instance, passive physical interface controls are capable of being produced on a small scale for specific uses and assigned different functionalities. This level of customization results in passible physical interface controls that are useful to meet a variety of business, entertainment, and creative applications.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-9.

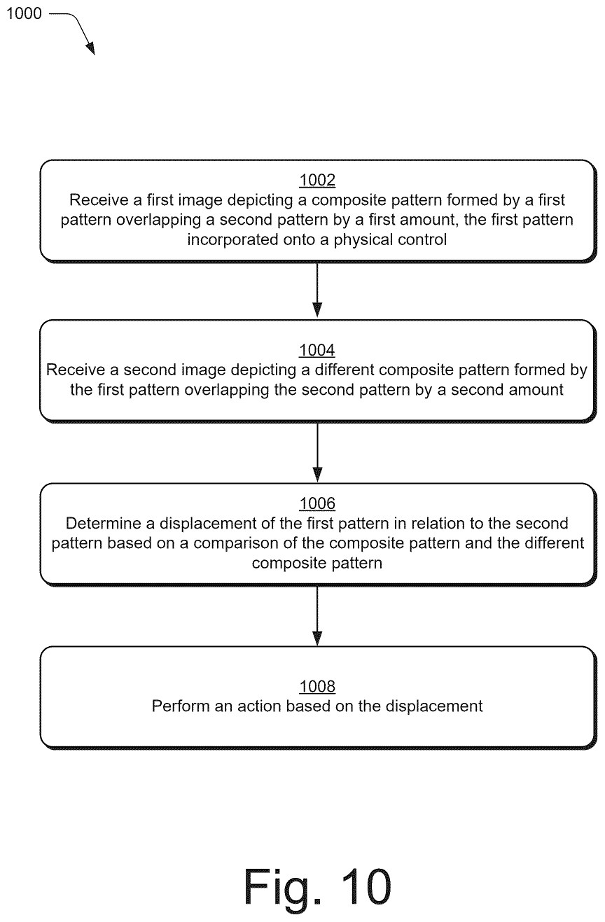

FIG. 10 depicts a procedure 1000 in an example implementation of determining movement of passive physical interface controls. At block 1002, a first image 126 is received depicting a composite pattern formed by a first pattern overlapping a second pattern by a first amount, the first pattern incorporated onto a physical control. For example, the physical control is a passive, non-electronic control. For instance, the physical control is at least one of a button 402, a joystick 502, a switch 602, a dial 702, or a slider 802 in some examples.

At block 1004, a second image 128 is received depicting a different composite pattern formed by the first pattern overlapping the second pattern by a second amount. For example, the composite pattern and the different composite pattern depict Moiré patterns formed by the first pattern and the second pattern overlapping at different amounts. In some examples, the first image and the second image are frames of a digital video captured during the displacement of the physical control.

At block 1006, a displacement 118 of the first pattern in relation to the second pattern is determined based on a comparison of the composite pattern and the different composite pattern. In an example, the comparison of the composite pattern and the different composite pattern involves at least one of a one-dimensional translation 302, a two-dimensional translation 304, or a rotational translation 306 formed by movement of the first pattern relative to the second pattern. Additionally, in some examples the composite pattern depicted in the first image is identified and a visual signal is generated by adjusting a perspective of the composite pattern. Additionally or alternatively, a blurred visual signal is generated and a sine wave is fitted to the blurred visual signal to determine the displacement 118.

At block 1008, an action is performed based on the displacement 118. In some examples, information related to the displacement 118 is transmitted to a device configured for performing the action based on the displacement 118.

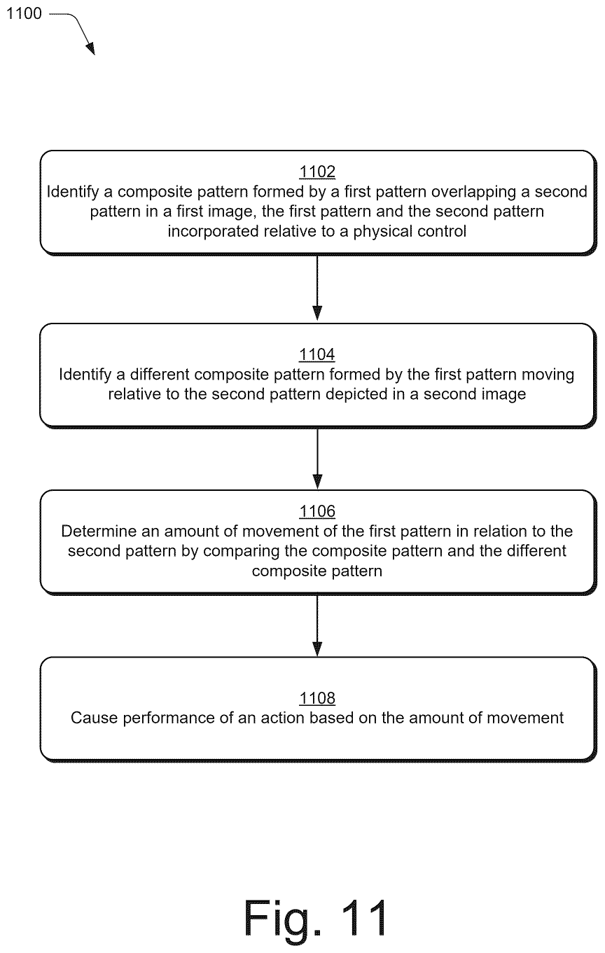

FIG. 11 depicts a procedure 1100 in an additional example implementation of determining movement of passive physical interface controls. At block 1102, a composite pattern formed by a first pattern overlapping a second pattern in a first image 126 is identified, the first pattern and the second pattern incorporated relative to a physical control. For example, the physical control is a passive, non-electronic control. In an example, the physical control is at least one of a button 402, a joystick 502, a switch 602, a dial 702, or a slider 802. For example, predetermined markers identifying edges or corners of the composite pattern are identified using an image recognition model.

At block 1104, a different composite pattern formed by the first pattern moving relative to the second pattern depicted in a second image 128 is identified. In some examples, the composite pattern and the different composite pattern depict Moiré patterns formed by the first pattern and the second pattern overlapping at different amounts. Additionally or alternatively, the first image 126 and the second image 128 are frames of a digital video captured during the movement of the physical control in relation to the second pattern.

At block 1106, an amount of movement of the first pattern in relation to the second pattern is determined by comparing the composite pattern and the different composite pattern. For example, the amount of movement relates to at least one of a one-dimensional translation 302, a two-dimensional translation 304, or a rotational translation 306 formed by movement of the first pattern relative to the second pattern. In some examples, the composite pattern depicted in the first image 126 is identified and a visual signal is generated by adjusting a perspective of the composite pattern.

At block 1108, performance of an action is caused based on the amount of movement. For example, instructions are generated for performing the action based on the amount of movement, which is pre-associated with the physical control in some examples.

### Example System and Device

FIG. 12 illustrates an example system generally at 1400 that includes an example computing device 1202 that is representative of one or more computing systems and/or devices that implement the various techniques described herein. This is illustrated through inclusion of the interface module 116. The computing device 1202 is configurable, for example, as a server of a service provider, a device associated with a client (e.g., a client device), an on-chip system, and/or any other suitable computing device or computing system.

The example computing device 1202 as illustrated includes a processing system 1204, one or more computer-readable media 1206, and one or more I/O interface 1208 that are communicatively coupled, one to another. Although not shown, the computing device 1202 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1204 is representative of functionality to perform one or more operations using hardware. Accordingly, the processing system 1204 is illustrated as including hardware element 1210 that is configurable as processors, functional blocks, and so forth. This includes implementation in hardware as an application specific integrated circuit or other logic device formed using one or more semiconductors. The hardware elements 1210 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1206 is illustrated as including memory/storage 1212. The memory/storage 1212 represents memory/storage capacity associated with one or more computer-readable media. The memory/storage 1212 includes volatile media (such as random access memory (RAM)) and/or nonvolatile media (such as read only memory (ROM), Flash memory, optical disks, magnetic disks, and so forth). The memory/storage 1212 includes fixed media (e.g., RAM, ROM, a fixed hard drive, and so on) as well as removable media (e.g., Flash memory, a removable hard drive, an optical disc, and so forth). The computer-readable media 1206 is configurable in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1202. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1202, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1210. The computing device 1202 is configured to implement particular instructions and/or functions corresponding to the software and/or hardware modules. Accordingly, implementation of a module that is executable by the computing device 1202 as software is achieved at least partially in hardware, e.g., through use of computer-readable storage media and/or hardware elements 1210 of the processing system 1204. The instructions and/or functions are executable/operable by one or more articles of manufacture (for example, one or more computing devices and/or processing systems 1204) to implement techniques, modules, and examples described herein.

The techniques described herein are supported by various configurations of the computing device 1202 and are not limited to the specific examples of the techniques described herein. This functionality is also implementable through use of a distributed system, such as over a “cloud” 1114 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 include applications and/or data that can be utilized when computer processing is executed on servers that are remote from the computing device 1202. Resources 1218 can also include services provided over the Internet and/or through a subscriber network, such as a cellular or Wi-Fi network.

The platform 1216 abstracts resources and functions to connect the computing device 1202 with other computing devices. The platform 1216 also serves to abstract scaling of resources to provide a corresponding level of scale to encountered demand for the resources 1218 that are implemented via the platform 1216. Accordingly, in an interconnected device embodiment, implementation of functionality described herein is distributable throughout the system 1200. For example, the functionality is implementable in part on the computing device 1202 as well as via the platform 1216 that abstracts the functionality of the cloud 1214.

What is claimed is:

1. A method comprising:
receiving, by a processing device, a first image depicting a composite pattern formed by a first pattern overlapping a second pattern by a first amount, the first pattern incorporated onto a physical control;
receiving, by the processing device, a second image depicting a different composite pattern formed by the first pattern overlapping the second pattern by a second amount;
determining, by the processing device, a displacement of the first pattern in relation to the second pattern based on a comparison of the composite pattern and the different composite pattern; and
performing, by the processing device, an action based on the displacement.

2. The method of claim 1, wherein the composite pattern and the different composite pattern depict Moiré patterns formed by the first pattern and the second pattern overlapping at different amounts.

3. The method of claim 1, wherein the first image and the second image are frames of a digital video captured during movement of the physical control.

4. The method of claim 1, wherein the physical control is a passive, non-electronic control.

5. The method of claim 1, further comprising transmitting information related to the displacement to a device configured for performing the action based on the displacement.

6. The method of claim 1, wherein the physical control is at least one of a button, a joystick, a switch, a dial, or a slider.

7. The method of claim 1, wherein the comparison of the composite pattern and the different composite pattern involves at least one of a one-dimensional translation, a two-dimensional translation, or a rotational translation formed by movement of the first pattern relative to the second pattern.

8. The method of claim 1, further comprising identifying the composite pattern depicted in the first image and generating a visual signal by adjusting a perspective of the composite pattern.

9. The method of claim 8, further comprising generating a blurred visual signal and fitting a sine wave to the blurred visual signal to determine the displacement.

10. A system comprising:
a memory component; and
a processing device coupled to the memory component, the processing device to perform operations comprising:
identifying a composite pattern formed by a first pattern overlapping a second pattern in a first image, the first pattern and the second pattern incorporated relative to a physical control;
identifying a different composite pattern formed by the first pattern moving relative to the second pattern depicted in a second image;
determining an amount of movement of the first pattern in relation to the second pattern by comparing the composite pattern and the different composite pattern; and
causing performance of an action based on the amount of movement.

11. The system of claim 10, wherein the composite pattern and the different composite pattern depict Moiré patterns formed by the first pattern and the second pattern overlapping at different amounts.

12. The system of claim 10, wherein the first image and the second image are frames of a digital video captured during the movement of the physical control in relation to the second pattern.

13. The system of claim 10, wherein the physical control is a passive, non-electronic control.

14. The system of claim 10, wherein the physical control is at least one of a button, a joystick, a switch, a dial, or a slider.

15. The system of claim 10, wherein the amount of movement relates to at least one of a one-dimensional translation, a two-dimensional translation, or a rotational translation formed by movement of the first pattern relative to the second pattern.

16. The system of claim 10, further comprising identifying the composite pattern depicted in the first image and generating a visual signal by adjusting a perspective of the composite pattern.

17. A method comprising:
identifying, by a processing device, a composite pattern depicted in a first frame of a digital video, the composite pattern formed by a first pattern overlapping a second pattern;
detecting, by the processing device, movement of the first pattern in relation to the second pattern;
determining, by the processing device, a displacement corresponding to the movement of the first pattern in relation to the second pattern based on identifying a different composite pattern formed by the movement of the first pattern in relation to the second pattern; and
executing, by the processing device, a task based on the displacement.

18. The method of claim 17, wherein the composite pattern and the different composite pattern depict Moiré patterns formed by the first pattern and the second pattern overlapping at different amounts.

19. The method of claim 17, wherein the first pattern is incorporated onto a physical control.

20. The method of claim 17, wherein the displacement relates to at least one of a one-dimensional translation, a two-dimensional translation, or a rotational translation formed by the movement of the first pattern relative to the second pattern.
